(19) United States
(12) Patent Application Publication
(10) Pub. No.: US 2005/0115044 A1
(43) Pub. Date: Jun. 2, 2005

(54) Zip fastener device for the junction of two leather strips, method of making such a device and corresponding article

(75) Inventor: Patrick Jeandel, Paris (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: HERMES SELLIER, Paris (FR)

(21) Appl. No.: 11/023,800

(22) Filed: Dec. 29, 2004

Related U.S. Application Data
(62) Division of application No. 10/624,505, filed on Jul. 23, 2003.

(30) Foreign Application Priority Data
Jul. 24, 2002 (FR) 02 09394

(51) Int. Cl. B29D 5/00; B21F 45/18

(52) U.S. Cl. 29/410; 29/408; 29/409

(57) ABSTRACT

The zip fastener device for joining two strips (2 and 3) comprising two rows of teeth (4 and 5) able to engage with each other mutually under the action of a slider (6) and applied respectively to one of the edges (7 and 8) of each of the said two strips (2 and 3), the material of at least one of the two strips (2 and 3) being of the leather or simulation leather type, characterised in that the said strip is formed by a piece (9) folded in two, in that the area forming a fold (10) is filled longitudinally with a rod (11) of chosen thickness and in that the teeth (4 and 5) are applied at least partially around the said fold area (10) thus filled.

The present invention concerns a zip fastener device for joining two strips of leather, a method of producing the said device and an article using such a zip fastener device.

Zip fastener devices are already known for joining two strips of textiles on which hooks or teeth are mounted, able to engage mutually under the action of a slider.

In practice, textile strips have an even thickness. In addition, they are generally the same thickness for the entire range of zip fasteners. As a result such textile strips meet with great success and hold a quasi-monopoly with zip fasteners.

The Applicant first of all posed the problem of substituting leather strips for textile strips and then resolving the problems of production posed by this substitution since leather is not of even thickness and is also relatively thick.

The documents U.S. Pat. No. 1,949,889, DE-671 275 and U.S. Pat. No. 1,933,290 suggest this substitution without however dealing with the problem of the difficulty in implementing it. In fact, none of these documents proposes a solution for overcoming the problem of irregular thickness of the leather strip.

The document U.S. Pat. No. 3,885,275 for its part describes the holding of a core inside a fold, the core being for example a rod. This document does not describe the arrangement of a zip fastener on one or two strips of leather.

The present invention affords precisely a solution to these problems.

It relates to a zip fastener device for joining two strips, comprising two rows of teeth able to engage mutually under the action of a slider and applied respectively to one of the edges of each of the said two strips.

According to a general definition of the invention, the material of at least one of the two strips is of the leather or simulation leather type and is formed from a piece folded in two, the area forming the fold being filled longitudinally with a rod with a chosen thickness and the teeth being applied at least partially around the fold area thus filled.

The material of the two strips is preferably leather or simulation leather.

Thus, according to the invention, the thickness of the rod makes it possible to even out the thickness of the leather strip area which serves as a support for the mounting of the teeth. The result is a correct and satisfactory mounting of the teeth whose implementation can easily be automated:

According to another aspect of the invention, the two parts of the piece forming the strip are adhesively bonded to each other.

According to another characteristic, the rod is produced from a material belonging to the group formed by cotton, linen, plastics material or non-woven material.

Another object of the present invention is a method of producing a zip fastener device of the type comprising the following steps:
a) providing two strips;
b) applying a row of teeth to one of the edges of each of the said strips, the two rows of teeth being able to engage with each other mutually under the action of a slider, characterised in that step a) makes provision for producing at least one of the two strips from a material of the leather or simulation leather type.

Step a) preferably makes provision for producing the two strips from leather or simulation leather.

Advantageously, the method according to the invention also comprises a step of treatment of the strips of the slitting type for making the thickness of the said strips even.

According to a preferred embodiment, step a) comprises the following steps:
a1) forming each strip of leather or simulation leather from a piece folded in two, and
a2) longitudinally filling the area forming a fold with a rod of chosen thickness until the rod is placed inside the area forming a fold.

Step a) preferably also comprises step a3) consisting, after step a2), of adhesively bonding the two parts of the piece forming the strip to each other.

According to another aspect of the invention, step b) consists of applying the teeth around the area forming a fold thus filled.

The present invention also relates to an article using a zip fastener device according to the invention and/or implemented according to the method according to the invention.

Other characteristics and advantages of the invention will emerge in the light of the following detailed description and the drawings, in which:

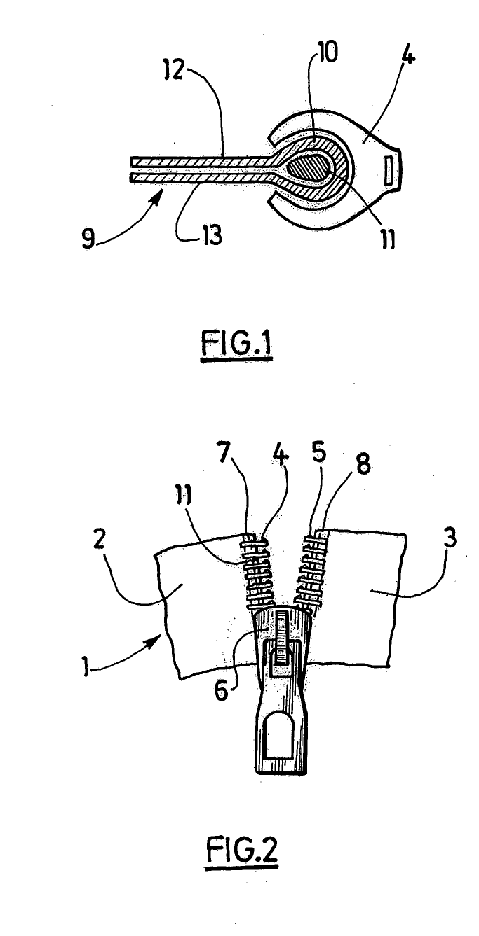

FIG. 1 is a front view of a zip fastener device comprising two strips of leather produced according to the invention, and

FIG. 2 is a view in section of a strip of leather produced according to the method according to the invention.

With reference to FIGS. 1 and 2, the zip fastener device 1 according to the invention makes it possible to join two leather strips 2 and 3.

In a variant which is not shown, only the strip 2 is produced from leather or simulation leather whilst the strip 3 is produced from textile for example.

The zip fastener device is of the type comprising two rows of teeth 4 and 5 able to engage with each other mutually under the action of a slider 6.

The teeth 4 and 5 are applied respectively to one 7 and 8 of each of the said two strips 2 and 3.

The method of producing the zip fastener device according to the invention first of all comprises the following steps:
a1) forming each strip of leather or simulation leather 2 and 3 from a piece 9 folded into two parts 12 and 13,
a2) longitudinally filling the area forming a fold 10 with a rod 11 of chosen thickness until the rod is placed inside the area forming a fold, and
a3) adhesively bonding the two parts 12 and 13 of the piece 9 forming the strip 2 and 3 to each other.

The rod or wire 11 here evens up the thickness of the leather in the area forming a support for mounting the teeth 4 and 5.

The diameter or thickness of the rod 11 is chosen here according to the angle of opening of the teeth.

In practice the rod is produced from a material belonging to the group formed by cotton, linen, plastics material or non-woven material.

Finally, according to step b), provision is made for applying the teeth 4 and 5 around the area forming a fold thus filled.

In practice, the application (or mounting) of the teeth is carried out by means of a machine which individually (or in blocks) applies at least partially around the edges thus defined by the rods 11.

Preferably, the slider 6 has a blunted bottom edge in order to limit abrasion of the strips whilst said slider is passing.

The method advantageously also comprises a step of treating the strips of the type involving splitting of the leather in order to even up the thickness of the said strips.

The zip fastener device according to the invention finds a use and/or application for any article, and any field, in particular in the leather trade.

For example, the article is produced essentially from leather or simulation leather and the strips of the zip fastener device being either attached or constituting a wall of the article.

1. A method of producing a zip fastener device of the type comprising:
providing two strips;
applying a row of teeth to one of the edges of each of the said strips, the two rows of teeth being able to engage with each other mutually under the action of a slider, wherein the providing comprises producing at least one of the two strips from a leather material or a simulation leather material.

2. A method according to claim 1, wherein the providing comprises producing the two strips from a leather material or a simulation leather material.

3. A method according to claim 1, further comprising:
treating the strips of the slitting type for evening up the thickness of the strips.

4. A method according to claim 1, wherein the providing comprises forming each strip of leather or simulation leather from a piece folded in two parts, and longitudinally filling the area forming a fold with a rod of chosen thickness until the rod is placed inside the area forming a fold.

5. A method according to claim 4, wherein the providing comprises, subsequent to the longitudinally filling, adhesively bonding to each other the two parts of the piece forming the strip.

6. A method according to claim 4, wherein the applying comprises applying the teeth at least partially around the area forming a fold thus filled.
